(19) United States
(12) Patent Application Publication
(10) Pub. No.: US 2013/0309033 A1
(43) Pub. Date: Nov. 21, 2013

(54) FIXTURE AND SYSTEM FOR PRODUCING SIDE-MILLED KEYS

(71) Applicant: Robert Sieveking, Rockford, IL (US)

(72) Inventor: Robert Sieveking, Rockford, IL (US)

(21) Appl. No.: 13/895,296

(22) Filed: May 15, 2013

Related U.S. Application Data
(60) Provisional application No. 61/647,505, filed on May 15, 2012.

(51) Int. Cl. B23C 3/35

(52) U.S. Cl. CPC B23C 3/355
USPC 409/81

(57) ABSTRACT

A fixture and system allows a locksmith to create side-milled high security keys to dimension (code) without the need for depth and space keys or expensive digitally controlled key making machinery. The fixture allows the locksmith to accurately and quickly create the side-milled key profile cuts in a key blank using a simple pattern key. The pattern key can be produced on common code cutting machinery. The fixture and system facilitates the making of the pattern key and holds the pattern in such a way as to allow the pattern to be easily traced over a blank key using a side-milled key duplicating machine. The system completely eliminates the need for special depth and space key sets, complicated and expensive digital key machinery and the time required to trace individual cuts over the side-milled key blank. The fixture and system saves time and simplifies the making of side-milled keys.

### CROSS-REFERENCE TO RELATED APPLICATION

This application claims the benefit of priority of U.S. provisional application number 61/647,505, filed May 15, 2012, the contents of which are herein incorporated by reference.

### BACKGROUND OF THE INVENTION

The present invention relates to locksmith tools and, more particularly, to a fixture and system which allows the locksmith to produce side-milled keys accurately and quickly.

The side milled key is unique in that the key is cut on the sides of the blank instead of the edges, as is common with standard keys. This complicates the key cutting process by requiring special equipment to produce a working key. It also gives the opportunity to increase the number of cuts possible on a key blade. Most side milled keys are reversible or “convenience.” This means that the key can be inserted into the cylinder with either side of the key blade up. Convenience keys are cut with the same combination on either face of the key.

Current technology requires the use of specialized key making machinery or time consuming single position key duplication from depth and space keys. Both are complicated to use and often produce mis-cut (unusable) keys. Depth and space key sets are confusing, time consuming to use and, most importantly, inaccurate. Digital key making machinery for side milled key making is expensive, requires a computer interface, do not work well in a mobile application and are largely cumbersome and unreliable in the field. This machinery is only useful in a shop or fixed location.

As can be seen, there is a need for an improved fixture and system for producing side-milled keys accurately and quickly.

### SUMMARY OF THE INVENTION

In one aspect of the present invention, a key duplication system comprises a clamping fixture; a vise jaw operable to clamp onto the clamping fixture; a clamp rail extending from a bottom side of the clamping fixture, the clamp rail fitting onto a key duplication machine; a pattern key having end cuts corresponding to a bitting code of an original side milled key to be duplicated, the pattern key operable to be clamped in a key well of the clamping fixture by the vise jaw; and a code card providing details for forming the pattern key from the original side milled key.

In another aspect of the present invention, a key duplication system comprises a clamping fixture; a vise jaw operable to clamp onto the clamping fixture; a clamp rail extending from a bottom side of the clamping fixture, the clamp rail fitting onto a key duplication machine; a pattern key having end cuts corresponding to a bitting code of an original side milled key to be duplicated, the pattern key operable to be clamped in a key well of the clamping fixture by the vise jaw; a code card providing details for forming the pattern key from the original side milled key; and a clamp screw for securing the vise jaw to the clamping fixture, wherein the vise jaw includes one of a standard vice jaw, securing the pattern key against a key fence of the clamping fixture, and an extended vice jaw, securing the pattern key against a key shim rail thereof.

In a further aspect of the present invention, a key duplication system comprises a clamping fixture, the clamping fixture including a key vise moving jaw and a key vise fixed jaw adjustably connected by a key vise clamping screw; a vise jaw operable to clamp onto the clamping fixture; a clamp rail extending from a bottom side of the clamping fixture, the clamp rail fitting onto a key duplication machine; a pattern key having end cuts corresponding to a bitting code of an original side milled key to be duplicated, the pattern key operable to be clamped in a key well of the clamping fixture by the vise jaw; a code card providing details for forming the pattern key from the original side milled key; and a precision spacing bar disposed in a space between the key vise moving jaw and the key vise fixed jaw.

These and other features, aspects and advantages of the present invention will become better understood with reference to the following drawings, description and claims.

### BRIEF DESCRIPTION OF THE DRAWINGS

FIG. 1 is a perspective view of a portion of a key making system according to an exemplary embodiment of the present invention;

FIG. 2 is an end view of an assembled vise jaw with a pattern key disposed therewithin according to an exemplary embodiment of the present invention;

FIG. 3 is a perspective view of the assembled vise jaw of FIG. 2;

FIG. 4 is a top view of two vise jaws according to exemplary embodiments of the present invention;

FIG. 5 is a top view of a fixture for clamping one of the vise jaws of FIG. 4;

FIG. 6 is a perspective view of a clamp screw for clamping one of the vise jaws of FIG. 4 to the fixture of FIG. 5;

FIGS. 7A through 7D are top views of exemplary fixture orientation options;

FIG. 8 is a top view of a pattern key used in the system of FIG. 1;

FIGS. 9A and 9B show side views of vise jaws A and B in the fixture of FIG. 5;

FIG. 10 is side view of a vise jaw according to an alternate embodiment of the present invention; and

FIG. 11 is a side view of a vise jaw according to another alternate embodiment of the present invention.

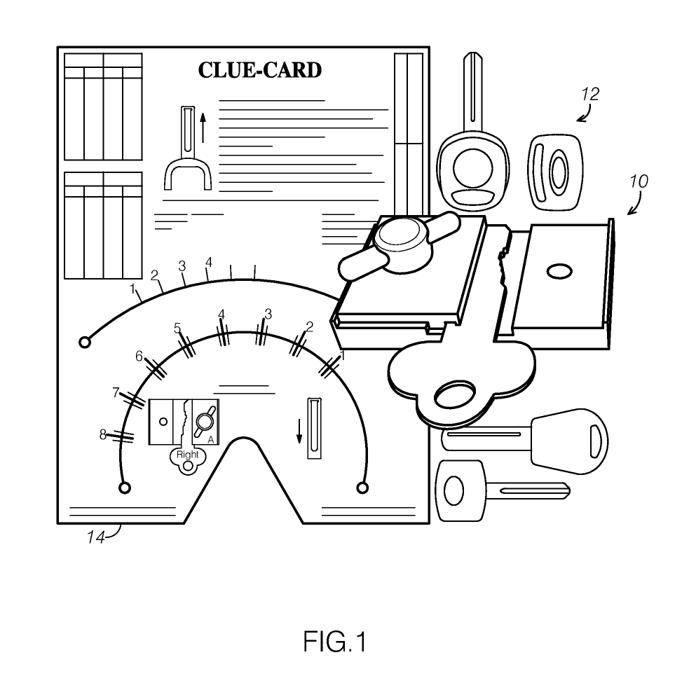

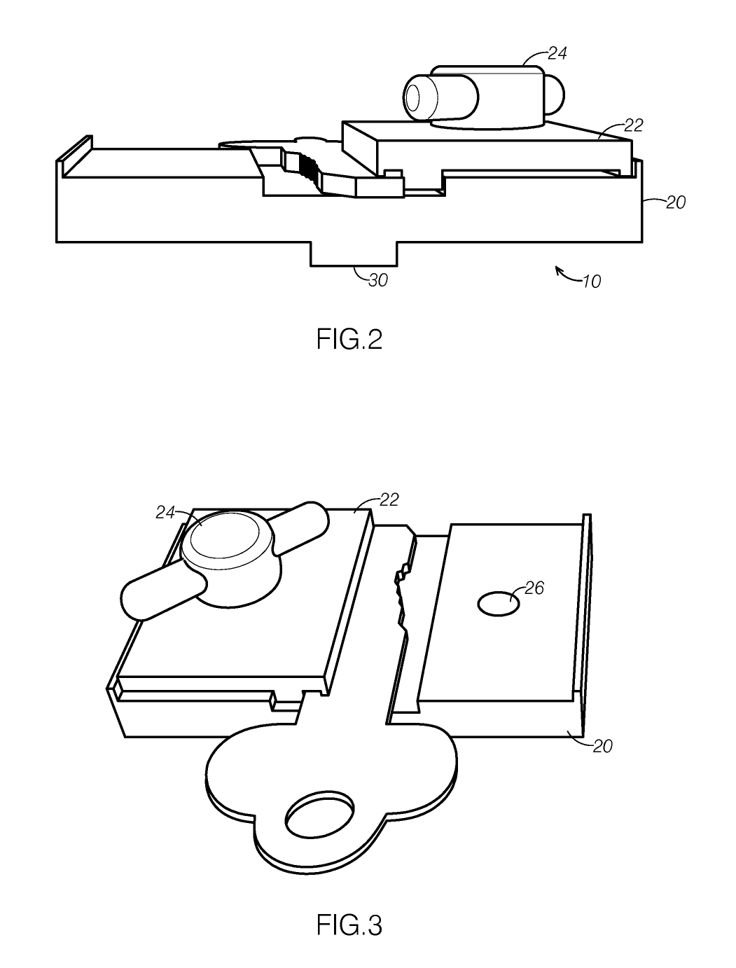

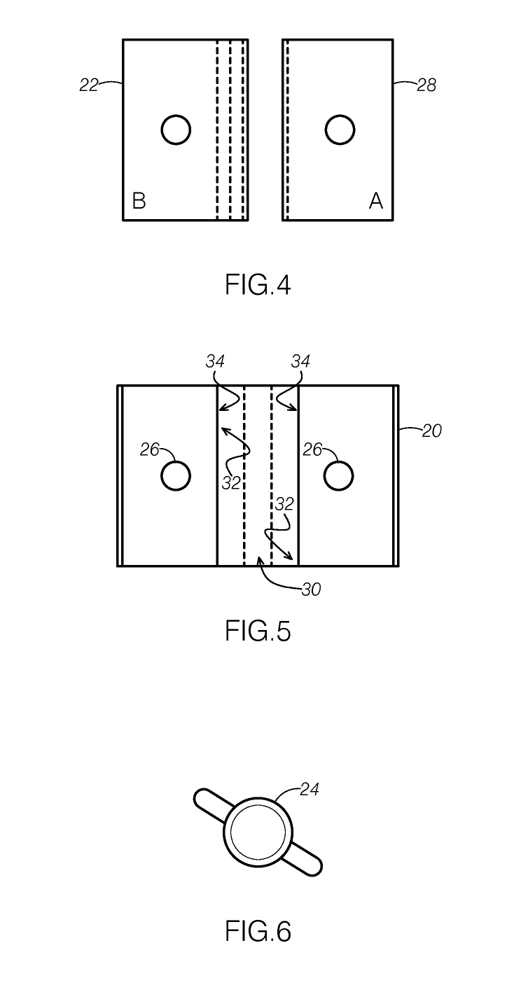

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fixture and system that allows a locksmith to create side-milled high security keys to dimension (code) without the need for depth and space keys or expensive digitally controlled key making machinery. The fixture of the present invention allows the locksmith to accurately and quickly create the side-milled key profile cuts in a key blank using a simple pattern key. The pattern key can be produced on common code cutting machinery. The fixture and system of the present invention facilitates the making of the pattern key and holds the pattern in such a way as to allow the pattern to be easily traced over a blank key using a side-milled key duplicating machine. Pattern keys are made from commonly available flat brass key blanks. The system of the present invention completely eliminates the need for special depth and space key sets, complicated and expensive digital key machinery and the time required to trace individual cuts over the side-milled key blank. The fixture and system of the present invention saves time and simplifies the making of side-milled keys.

Currently technology requires the use of specialized key making machinery or time consuming single position key duplication from depth and space keys. The system and fixture of the present invention allows a complete pattern, containing all cut positions and depths, to be used to produce the working key in a single pass.

Referring now to the Figures, a common flat brass “safe deposit” key blank 36 (also referred to as a pattern key 36) can be placed in the key vise of the code cutting key machine (not shown). A “Code Card” 14 can be inserted into the same code cutting machine. The code machine utilizes the specially calibrated scales found on the code card to locate and gauge cuts to be made in the pattern key 36. The key cut configuration (Code) is cut into the pattern key 36 according to the “bitting” of the key to be produced. The completed pattern key 36 can be cut to contain all of the cuts to be made on the side milled key blank 12.

The cut pattern key 36 can be transferred to a pattern fixture 10. The key is gauged and clamped in position by a vise jaw 22, 28. The vise jaw 22, 28 can be secured by tightening a clamp screw 24 in a tapped hole 26 in a clamp fixture 20 to fix the pattern key 36 in position in a key well 36 of the pattern fixture 10. The assembled pattern key 36 and pattern fixture 10 can be installed into the side milling key duplicator, on the pattern side of the machine. The appropriate side milled key blank can be installed on the milling side of the key duplicator (not shown).

The pattern key 36 can be traced by the key duplicator to produce the desired bitting pattern in the side milled key blank. The side milled key bitting pattern or profile is the duplicate of the pattern key profile. If the side milled key is double sided, the key blank is reversed and the pattern is duplicated over the opposite side of the blank, to complete the key. The pattern key 36 is unique to the key bitting combination desired and can be used to create as many keys as are required.

Keys can be cut using tip gauging. The pattern key 36 and working key are similarly gauged in the side milling key duplicator, so the spacing and depths are accurately duplicated over the working key. By carefully tracing the pattern key over the working key, a duplicate key profile can be milled into the side of the working key.

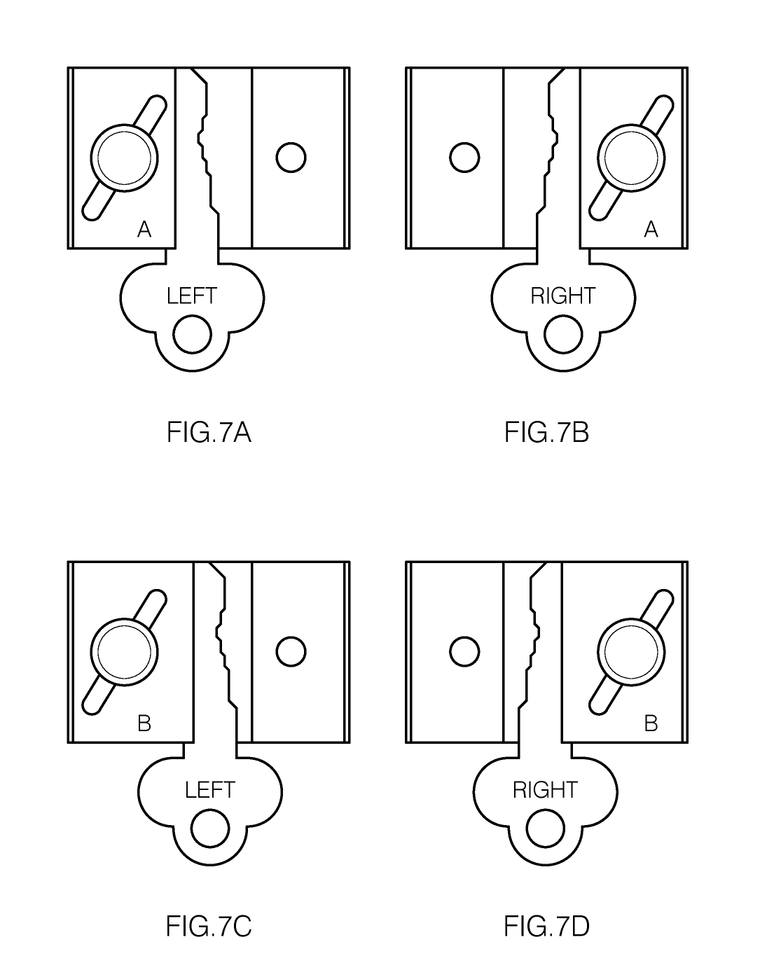

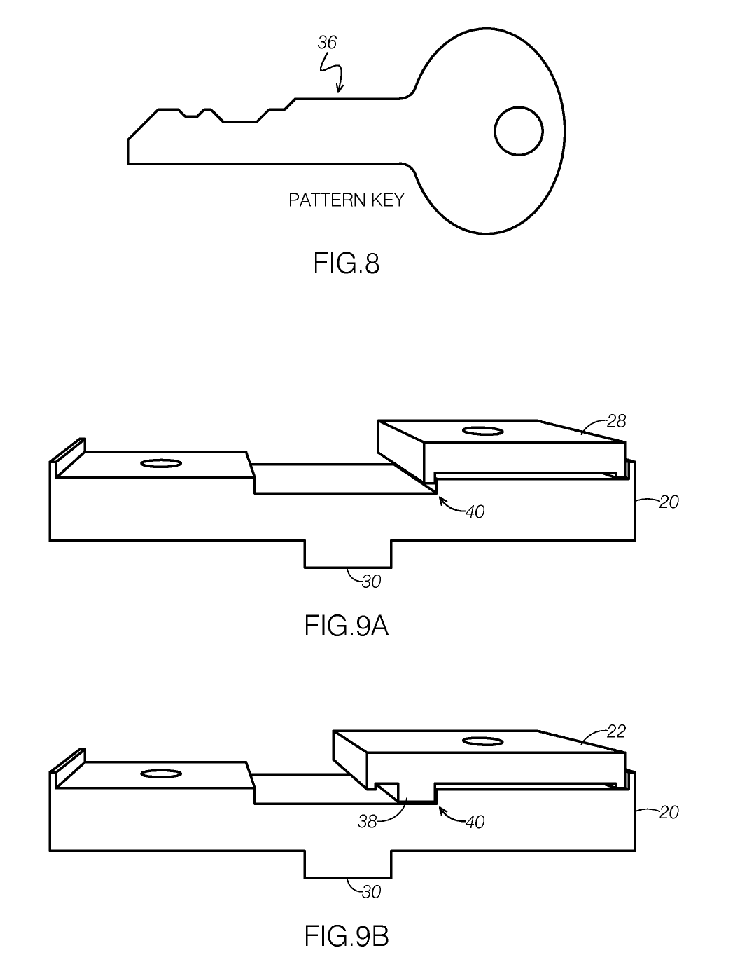

The pattern fixture 10 can be milled to produce a rail 30 along the underside of the fixture 10 that can clamp securely into a side milling key duplicating machine. The key well 32 can be milled into the top side of the fixture 10 to accommodate the pattern key 36 and gauge it parallel to and at a specific offset from the gauge side of the side milling key machine pattern key vise. The vise jaw 22, 28 and clamp screw 24 can be fashioned to clamp and hold the pattern key 36 securely into the key well 32 of the pattern fixture, preventing it from moving during the tracing or copying process. The fixture 10 can be made symmetrical, so as to allow it to be reversed for right hand and left hand application in cutting key bitting profiles that are made at the left or right side of the working key blade (see FIGS. 7A through 7D). One of the vise jaws can be an extended vise jaw 22 and can be made to incorporate a shim rail 38 along its length to raise the pattern key 36 away from the fixed gauge rail (key fence 34) for wide keys. The height profile of the pattern fixture 10 is such that it will allow the cutter and follower of the side milling key duplicator to be offset to allow the pattern to be traced and the key to be cut at the proper depth.

Code cards 14 are made and the depth and space scaled calibrated to produce the specific manufacturers “cut spacing” and “depth requirements” for each of the designed key configurations. Code cards are specific to each lock/key manufacturers published depth and space requirements. Cards are specific to left and right hand key “tracks,” as many configurations will have a right track and a left track, which may use different cut position (spacing) dimensions.

The locksmith will use the fixture and system of the present invention to create side milled keys to code or to dimension using a standard code cutting key machine and a simple side milling key duplicator. By producing a pattern key 36 containing all of the cut profile depths at the correct cut spacing over one pattern, the pattern can be used to create a complicated bitting pattern over the working key quickly and accurately without the time consuming and complicated process of using depth and space keys or the unnecessary expense and need for computer controlled digital key making machinery.

The system and fixture of the present invention simplifies and makes side milled key generation faster and more accurate. The system also allows for the creation of keys with half depth cuts for use in impressioning keys when the cut depths are unknown. It simplifies the process of key progression, when only one or two unknown cuts must be found by trial and error progression techniques.

Pattern keys can be made to produce oversize keys (cuts made intentionally shallow) to compensate for wear in the lock cylinder or tumblers. No other system, machine or fixture offers half-cut depth adjustment. Specific information on each Code Card allows a customer's key to be decoded using a caliper, to gauge and decode the cut depths to find the bitting of a key.

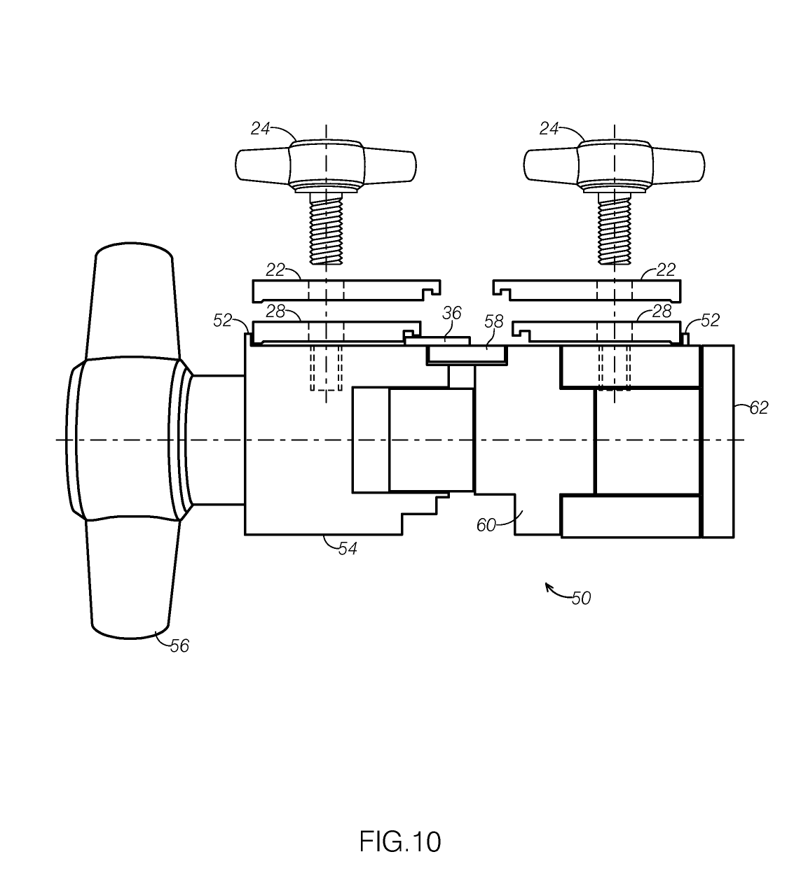

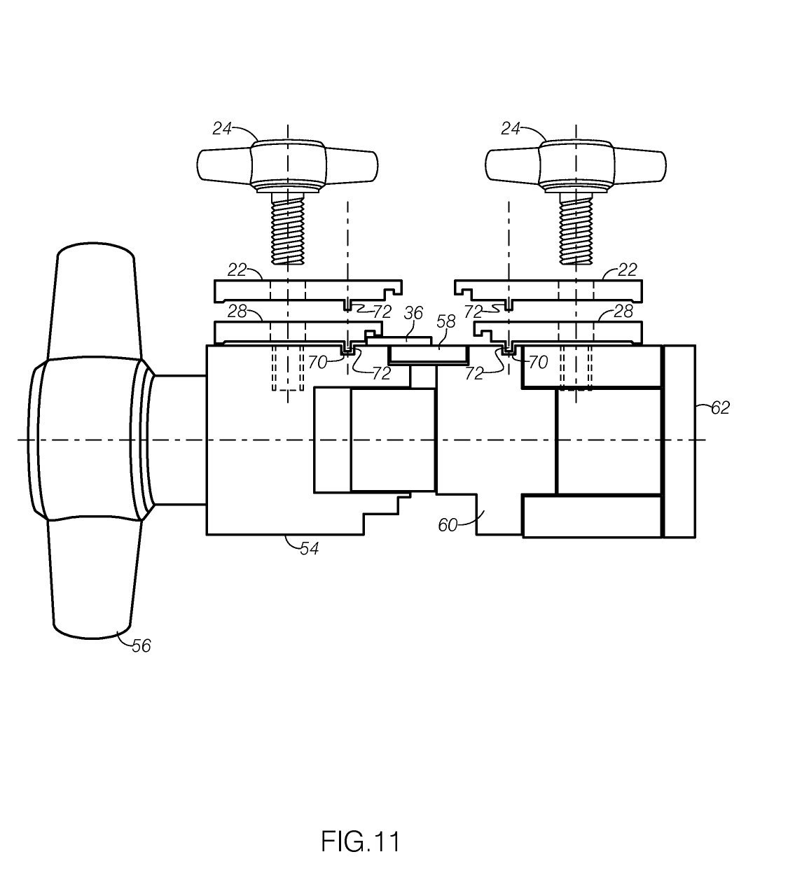

Referring now to FIGS. 10 and 11, variations in the pattern fixture 10 are contemplated within the scope of the present invention. For example, in FIG. 10, a first alternate pattern fixture 50 can include vise jaws 22, 28, as described above, that can attach to a clamp fixture with clamping screws 24. The clamp fixture, however, can be made in two pieces, a key vise moving jaw 54 and a key vise fixed jaw 60. A key vise clamping nut 62 can be fixed to the key vise fixed jaw 60 and a key vise clamping screw 56 can pass through the key vise moving jaw 54 to be threaded into the clamping nut 62. A precision spacing bar 58 can fit between the key vise moving jaw 54 and the key vise fixed jaw 60 to set a spacing therebetween. Vise jaw stop fences 52 can be provided on the key vise moving jaw 54 and the key vise fixed jaw 60 to help secure the vise jaws 22, 28 thereto.

Referring to FIG. 11, a second alternate clamping fixture can include vise jaw registering grooves 70 cut into the key vise moving jaw 54 and the key vise fixed jaw 60. The registering grooves 70 can receive clamp jaw rails 72 formed in the vise jaws 22, 28.

It should be understood, of course, that the foregoing relates to exemplary embodiments of the invention and that modifications may be made without departing from the spirit and scope of the invention as set forth in the following claims.

What is claimed is:

1. A key duplication system comprising:
a clamping fixture;
a vise jaw operable to clamp onto the clamping fixture;
a clamp rail extending from a bottom side of the clamping fixture, the clamp rail fitting onto a key duplication machine;
a pattern key having end cuts corresponding to a bitting code of an original side milled key to be duplicated, the pattern key operable to be clamped in a key well of the clamping fixture by the vise jaw; and
a code card providing details for forming the pattern key from the original side milled key.

2. The key duplication system of claim 1, wherein the vise jaw includes a standard vice jaw securing the pattern key against a key fence of the clamping fixture.

3. The key duplication system of claim 1, wherein the vise jaw includes an extended vice jaw securing the pattern key against a key shim rail thereof.

4. The key duplication system of claim 1, further comprising a clamp screw for securing the vise jaw to the clamping fixture.

5. The key duplication system of claim 1, further comprising stop fences disposed on the clamping fixture, the stop fences securing a side of the vice jaw.

6. The key duplication system of claim 1, wherein the clamping fixture includes a key vise moving jaw and a key vise fixed jaw adjustably connected by a key vise clamping screw.

7. The key duplication system of claim 6, further comprising a precision spacing bar disposed in a space between the key vise moving jaw and the key vise fixed jaw.

8. The key duplication system of claim 6, further comprising registering grooves disposed in the key vise moving jaw and the key vise fixed jaw, the registering grooves receiving a clamp jaw rail of the vise jaw.

9. A key duplication system comprising:
a clamping fixture;
a vise jaw operable to clamp onto the clamping fixture;
a clamp rail extending from a bottom side of the clamping fixture, the clamp rail fitting onto a key duplication machine;
a pattern key having end cuts corresponding to a bitting code of an original side milled key to be duplicated, the pattern key operable to be clamped in a key well of the clamping fixture by the vise jaw;
a code card providing details for forming the pattern key from the original side milled key; and
a clamp screw for securing the vise jaw to the clamping fixture, wherein
the vise jaw includes one of a standard vice jaw, securing the pattern key against a key fence of the clamping fixture, and an extended vice jaw, securing the pattern key against a key shim rail thereof.

10. A key duplication system comprising:
a clamping fixture, the clamping fixture including a key vise moving jaw and a key vise fixed jaw adjustably connected by a key vise clamping screw;
a vise jaw operable to clamp onto the clamping fixture;
a clamp rail extending from a bottom side of the clamping fixture, the clamp rail fitting onto a key duplication machine;
a pattern key having end cuts corresponding to a bitting code of an original side milled key to be duplicated, the pattern key operable to be clamped in a key well of the clamping fixture by the vise jaw;
a code card providing details for forming the pattern key from the original side milled key; and
a precision spacing bar disposed in a space between the key vise moving jaw and the key vise fixed jaw.
